(19) United States
(12) Patent Application Publication
(10) Pub. No.: US 2025/0086473 A1
(43) Pub. Date: Mar. 13, 2025

(54) MODEL TRAINING METHOD AND APPARATUS

(71) Applicant: HUAWEI TECHNOLOGIES CO., LTD., Shenzhen (CN)

(72) Inventors: Wen TONG, Ottawa (CA); Jianglei MA, Ottawa (CA); Rong LI, Boulogne Billancourt (FR); Jian WANG, Hangzhou (CN); Gongzheng ZHANG, Hangzhou (CN)

(21) Appl. No.: 18/959,944

(22) Filed: Nov. 26, 2024

Related U.S. Application Data
(63) Continuation of application No. PCT/CN2023/089751, filed on Apr. 21, 2023.

(30) Foreign Application Priority Data
May 27, 2022 (CN) 202210586086.5

(51) Int. Cl. G06N 3/096; G06N 3/045

(52) U.S. Cl. CPC G06N 3/096; G06N 3/045

(57) ABSTRACT

This application provides a model training method and apparatus. The method includes: A first processing node obtains at least one first model; the first processing node processes the at least one first model to generate a first common model; and the first processing node determines a second processing node, where the second processing node is a processing node for a next round of model processing, and the first common model is obtained by the second processing node before the next round of model processing. In technical solutions provided in this application, before the next round of model processing, a processing node for the next round of model processing may be determined based on an actual requirement, to adapt to a change of an application scenario.

### CROSS-REFERENCE TO RELATED APPLICATIONS

This application is a continuation of International Application No. PCT/CN2023/089751, filed on Apr. 21, 2023, which claims priority to Chinese Patent Application No. 202210586086.5, filed on May 27, 2022. The disclosures of the aforementioned applications are hereby incorporated by reference in their entireties.

### TECHNICAL FIELD

Embodiments of this application relate to the field of artificial intelligence, and more specifically, to a model training method and apparatus.

### BACKGROUND

With the advent of a big data era, each device generates a large amount of raw data in various forms every day. To make full use of the data for model training, currently two typical training architectures are centralized learning (centralized learning, CL) and federated learning (federated learning, FL).

The federated learning is a distributed machine learning method. In a federated learning process, model training may be performed on a plurality of edge devices by using local data of the plurality of edge devices, and then trained models are uploaded to a central server. The central server may serve as a processing node to aggregate the models from the plurality of edge devices to generate a common model, and deliver the common model to the plurality of edge devices, so that the plurality of edge devices can update the common model based on the local data. The steps are repeatedly performed until the model is converged or a quantity of training rounds reaches a preset upper limit, so that a high-performance machine learning model can be finally obtained.

In a current federated learning architecture, a processing node configured to generate a common model is fixed. For example, the common model can be generated only by a central server. However, in different application scenarios, using the central server as the processing node may not be an optimal solution, for example, with a change of a network topology structure and a change of data generated by the edge device.

### SUMMARY

This application provides a model training method and apparatus. In the method, before a next round of model processing, a processing node for the next round of model processing may be determined based on an actual requirement, to adapt to a change of an application scenario.

According to a first aspect, a model processing method is provided. The method may be performed by a processing device, or may be performed by a chip, a chip system, or a circuit configured in a processing device, which may be collectively referred to as a processing node. This is not limited in this application. The following uses an example in which a first processing node performs the method for description.

The method may include: The first processing node obtains at least one first model; the first processing node processes the at least one first model to generate a first common model; and the first processing node determines a second processing node, where the second processing node is a processing node for a next round of model processing, and the first common model is obtained by the second processing node before the next round of model processing.

According to the method in this embodiment, in a model training process, a preferred processing node may change with a change of a network topology structure and a change of data generated by each node. Therefore, the first processing node determines an appropriate processing node for the next round of model processing, so that a change of an application scenario can be better adapted, to improve model training performance.

With reference to the first aspect, in some implementations of the first aspect, the first processing node and the second processing node are different processing nodes, and the method further includes: The first processing node sends the first common model to the second processing node.

According to the method in this embodiment, when the first processing node and the second processing node are different processing nodes, the first processing node may transmit the generated common model to the second processing node, so that the second processing node can update and optimize the common model based on a common model obtained through a previous round of model processing, to improve model training efficiency and performance. In addition, because the second processing node may be randomly specified by the first processing node based on an actual requirement, the common model can be continuously transmitted between different nodes in a network through a plurality of rounds of model processing.

In addition, after generating the common model, the first processing node may send the common model to the second processing node, and does not need to deliver the common model to all participating nodes. Therefore, communication overheads are reduced.

With reference to the first aspect, in some implementations of the first aspect, the first processing node and the second processing node are a same processing node.

According to the method in this embodiment, a processing node (the first processing node) for a current round of model processing and a processing node (the second processing node) for the next round of model processing may be the same processing node. In this case, the first processing node may not need to send the first common model to the second processing node.

With reference to the first aspect, in some implementations of the first aspect, that the first processing node determines a second processing node includes: The first processing node determines the second processing node based on an indication of the first common model.

According to the method in this embodiment, the first processing node may determine the second processing node based on the indication of the first common model.

In an example, the first common model may indicate the second processing node to the first processing node based on a feature of the first common model. For example, the feature of the first common model may be a quantity of parameters of the first common model. In a possible case, the quantity of parameters of the first common model is large. Therefore, it is expected that the first common model is processed by a node with a strong computing capability. In this case, the first common model may indicate the first processing node to determine a node with the strong computing capability as the second processing node. For another example, the feature of the first common model may be a current functional feature of the first common model. For example, a current function of the first common model is a classification function. Therefore, if a node in the network has local data used for a classification learning task. In this case, the first common model may indicate the first processing node to determine the node as the second processing node.

In another example, the first common model may indicate the second processing node to the first processing node based on the parameter of the first common model. For example, the parameter of the first common model includes corresponding routing information, and the routing information may indicate the processing node for the next round of model processing, so that the first processing node can determine the second processing node based on the routing information in the first common model.

The method in this embodiment helps determine, for the first common model, the second processing node that matches the feature or a requirement of the first common model, and further helps improve model training performance.

With reference to the first aspect, in some implementations of the first aspect, that the first processing node obtains at least one first model includes: The first processing node receives the first model from at least one participating node.

According to the method in this embodiment, the first processing node may obtain the at least one first model by receiving the first model from the at least one participating node, in other words, the at least one first model may include the first model from the at least one participating node, so that the first processing node can make full use of the first model from the participating node to perform model processing, to generate a common model with better performance.

With reference to the first aspect, in some implementations of the first aspect, before the first processing node receives the first model from the at least one participating node, the method further includes: The first processing node sends indication information to the at least one participating node, where the indication information indicates the at least one participating node to send the first model of the at least one participating node to the first processing node.

According to the method in this embodiment, the at least one participating node may be triggered by using the indication information, to send (upload) the first model of the at least one participating node to the first processing node.

In a possible implementation, the participating node has generated the first model before receiving the indication information, in other words, the participating node has stored the first model locally. In this case, if the participating node receives the indication information from the first processing node, the participating node may upload the first model to the first processing node based on an indication of the indication information.

In another possible implementation, the participating node does not generate the first model when receiving the indication information, in other words, the participating node does not store the first model locally. In this case, if the participating node needs to participate in a model training task, the participating node may generate the first model after receiving the indication information from the first processing node, and then upload the generated first model to the first processing node.

With reference to the first aspect, in some implementations of the first aspect, that the first processing node obtains at least one first model includes: The first processing node generates the first model of the first processing node.

According to the method in this embodiment, the first processing node may further obtain the at least one first model in a manner of generating the first model by the first processing node, in other words, the at least one first model may further include the first model generated by the first processing node, so that the first processing node can make full use of a first model of each node in the network to perform model film processing, to generate a common model with better performance.

With reference to the first aspect, in some implementations of the first aspect, that the first processing node processes the at least one first model to generate a first common model includes: The first processing node performs aggregation processing on the at least one first model to generate the first common model.

According to the method in this embodiment, the first processing node may perform the aggregation processing on the at least one first model to generate the first common model. The aggregation processing may enable the at least one first model to be merged into a common model with better performance, to improve performance of the common model generated by the first processing node.

With reference to the first aspect, in some implementations of the first aspect, that the first processing node performs aggregation processing on the at least one first model to generate the first common model includes: The first processing node processes parameters of the at least one first model to generate the first common model.

According to the method in this embodiment, the first processing node may process the parameters of the at least one first model to generate a first common model with better performance.

In a possible implementation, the first processing node may generate the first common model in a manner of performing average processing on the parameters of the at least one first model, where a value of a parameter of the first common model is an average value of the parameters of the at least one first model.

In another possible implementation, the first processing node may alternatively generate the first common model in a manner of calculating another statistical value of the parameters of the at least one first model. For example, the first processing node may generate the first common model in a manner of calculating a median of the parameters of the at least one first model. In this case, a value of a parameter of the generated first common model is the median of the parameters of the at least one first model.

With reference to the first aspect, in some implementations of the first aspect, that the first processing node processes parameters of the at least one first model to generate the first common model includes: The first processing node performs average processing on the parameters of the at least one first model to generate the first common model, where a value of a parameter of the first common model is an average value of the parameters of the at least one first model. According to the method in this embodiment, the first processing node may generate

the first common model in a manner of performing the average processing on the parameters of the at least one first model, where the value of the parameter of the first common model is the average value of the parameters of the at least one first model.

It should be noted that, in some scenarios, the average processing may be weighted average processing, in other words, the first common model is generated by performing the weighted average processing on the parameters of the at least one first model. In this case, the value of the parameter of the generated first common model is a weighted average value of the parameters of the at least one first model.

With reference to the first aspect, in some implementations of the first aspect, the at least one first model has a same network structure.

According to the method in this embodiment, the at least one first model has the same network structure. In this way, it can be more convenient for the first processing node to process the parameters of the at least one first model.

With reference to the first aspect, in some implementations of the first aspect, the method further includes: The first processing node performs distillation processing on the at least one first model, where the distillation processing enables the at least one first model to have the same network structure.

According to the method in this embodiment, to enable the at least one first model to have the same network structure, the first processing node may perform the distillation processing on the at least one first model, where the distillation processing can enable the at least one first model to have the same network structure. In this way, it can be more convenient for the first processing node to process the parameters of the at least one first model.

With reference to the first aspect, in some implementations of the first aspect, that the first processing node performs aggregation processing on the at least one first model to generate the first common model includes: The first processing node splices the at least one first model to generate the first common model.

According to the method in this embodiment, the first processing node can generate a first common model with better performance by splicing the at least one first model. Network structures of the at least one first model may be the same or may be different.

For example, the first processing node may separately splice an input end and an output end of the at least one first model, to implement splicing of the at least one first model. For example, the first processing node may connect the input end of the at least one first model by using a single-layer perceptron, and combine the output end of the at least one first model into a single-layer output, to implement splicing of the at least one first model.

With reference to the first aspect, in some implementations of the first aspect, the at least one first model includes a second common model, and the second common model is a common model obtained through the previous round of model processing.

According to the method in this embodiment, the first processing node may generate a common model of the current round based on the second common model. In other words, the first processing node may further optimize the common model based on the common model obtained in the previous round, to further improve performance of the common model.

With reference to the first aspect, in some implementations of the first aspect, the method further includes: The first processing node receives the second common model from a third processing node, where the third processing node is a processing node for the previous round of model processing.

According to the method in this embodiment, when the first processing node and the third processing node are different processing nodes, the first processing node may receive the second common model from the third processing node, and further, the first processing node may optimize the common model based on the second common model, to further improve performance of the common model.

According to the method in this embodiment, the first processing node and the third processing node may be a same processing node, in other words, it is determined that the processing node for the previous round of model processing and the processing node for the current round of model processing are a same node.

With reference to the first aspect, in some implementations of the first aspect, the second processing node is determined based on one or more pieces of the following information: a network topology structure, data quality of the second processing node, and a computing capability of the second processing node.

In an example, the second processing node may be determined based on the network topology structure. For example, if a node is in a more advantageous position in the network topology structure (for example, the position facilitates the node in communicating with another node in the network), the node may be determined as the second processing node. This helps improve transmission efficiency of the model in the network.

In an example, the second processing node may be determined based on the data quality of the second processing node. For example, if data quality of a node is high, the node may be determined as the second processing node. For another example, if data quality of nodes in an area in the network is high, a node may be determined from the area as the second processing node. This helps improve performance of the common model generated by the second processing node.

In another example, the second processing node may be determined based on the computing capability of the second processing node. For example, computing capabilities of nodes may be compared, to determine a node with a stronger computing capability as the second processing node. This helps improve model training efficiency.

According to the method in this embodiment, when the second processing node is determined, one of the three pieces of information may be separately considered based on an actual task requirement, or any two or more pieces of information may be comprehensively considered. This helps determine an appropriate second processing node for a specific application scenario, to improve model training performance.

According to a second aspect, a model processing method is provided. The method may be performed by a processing node, or may be performed by a chip, a chip system, or a circuit configured in a processing node. This is not limited in this application. For ease of description, the following uses an example in which a first processing node performs the method for description.

The method may include: The first processing node obtains at least one first model; and the first processing node processes the at least one first model to generate a first common model, where the at least one first model includes a second common model, and the second common model is a common model obtained through a previous round of model processing.

According to the method in this embodiment, when the first processing node is a processing node for a last round of model processing, the first model may include the common model (the second common model) obtained through the previous round of model processing, so that the processing node for the last round of model processing may perform final model processing based on the common model obtained through the previous round of model processing, to obtain a high-performance common model.

For another implementation of the second aspect, refer to the foregoing descriptions of the first aspect. Details are not described herein again.

According to a third aspect, a model training apparatus is provided. The apparatus includes an obtaining unit and a processing unit. The obtaining unit is configured to obtain at least one first model. The processing unit is configured to process the at least one first model to generate a first common model. The processing unit is further configured to determine a second processing node, where the second processing node is a processing node for a next round of model processing, and the first common model is obtained by the second processing node before the next round of model processing.

With reference to the third aspect, in some implementations of the third aspect, the apparatus and the second processing node are different processing nodes. The apparatus further includes a sending unit, where the sending unit is configured to send the first common model to the second processing node. Optionally, the obtaining unit and the sending unit are a same unit, or the obtaining unit includes the sending unit.

With reference to the third aspect, in some implementations of the third aspect, the apparatus and the second processing node are a same processing node.

With reference to the third aspect, in some implementations of the third aspect, the processing unit is further configured to determine the second processing node based on an indication of the first common model.

With reference to the third aspect, in some implementations of the third aspect, the obtaining unit is further configured to receive the first model from at least one participating node.

With reference to the third aspect, in some implementations of the third aspect, the apparatus further includes the sending unit, where the sending unit is configured to send indication information to the at least one participating node, where the indication information indicates the at least one participating node to send the first model of the at least one participating node to the apparatus. Optionally, the obtaining unit and the sending unit are a same unit, or the obtaining unit includes the sending unit.

With reference to the third aspect, in some implementations of the third aspect, the obtaining unit is further configured to generate the first model of the apparatus. Optionally, the obtaining unit and the processing unit are a same unit, or the obtaining unit includes the processing unit.

With reference to the third aspect, in some implementations of the third aspect, the processing unit is further configured to perform aggregation processing on the at least one first model to generate the first common model.

With reference to the third aspect, in some implementations of the third aspect, the processing unit is further configured to process parameters of the at least one first model to generate the first common model.

With reference to the third aspect, in some implementations of the third aspect, the processing unit is further configured to perform average processing on the parameters of the at least one first model to generate the first common model, where a value of a parameter of the first common model is an average value of the parameters of the at least one first model.

With reference to the third aspect, in some implementations of the third aspect, the at least one first model has a same network structure.

With reference to the third aspect, in some implementations of the third aspect, the processing unit is further configured to perform distillation processing on the at least one first model, where the distillation processing enables the at least one first model to have the same network structure.

With reference to the third aspect, in some implementations of the third aspect, the processing unit is further configured to splice the at least one first model to generate the first common model.

With reference to the third aspect, in some implementations of the third aspect, the at least one first model includes a second common model, and the second common model is a common model obtained through a previous round of model processing.

With reference to the third aspect, in some implementations of the third aspect, the obtaining unit is further configured to receive the second common model from a third processing node, where the third processing node is a processing node for the previous round of model processing.

With reference to the third aspect, in some implementations of the third aspect, the second processing node is determined based on one or more pieces of the following information: a network topology structure, data quality of the second processing node, and a computing capability of the second processing node.

With reference to the third aspect, in some implementations of the third aspect, the obtaining unit includes the sending unit and/or the processing unit; or the obtaining unit and the sending unit or the processing unit are a same unit; or the obtaining unit and the sending unit or the processing unit are integrated into a same unit. Optionally, the processing unit may be a processor, a processing circuit, a logic circuit, or the like. The sending unit may be a transmitter, a transmitter circuit, a transceiver, a transceiver circuit, an input/output interface, a circuit, or the like.

According to a fourth aspect, a model training apparatus is provided. The apparatus is configured to perform the method provided in the second aspect.

Optionally, the apparatus may include a module configured to perform the method provided in the second aspect.

According to a fifth aspect, a computer-readable storage medium is provided. The computer-readable medium stores program code executed by a device, and the program code includes the method according to any possible implementation of the first aspect or the second aspect.

According to a sixth aspect, a computer program product is provided. When the computer program product runs on a computer, the computer is enabled to perform the method according to any possible implementation of the first aspect or the second aspect.

According to a seventh aspect, a communication apparatus is provided. The apparatus is configured to perform the method provided in the first aspect or the second aspect. Specifically, the apparatus may include units and/or modules configured to perform the method provided in any implementation of the first aspect or the second aspect, for example, a processing unit and/or a communication unit.

In an implementation, the apparatus is a processing device. When the apparatus is the processing device, the communication unit may be a transceiver or an input/output interface, and the processing unit may be at least one processor. Optionally, the transceiver may be a transceiver circuit. Optionally, the input/output interface may be an input/output circuit.

In another implementation, the apparatus is a chip, a chip system, or a circuit used in a processing device. When the apparatus is the chip, the chip system, or the circuit used in the processing device, the communication unit may be an input/output interface, an interface circuit, an output circuit, an input circuit, a pin, a related circuit, or the like on the chip, the chip system, or the circuit, and the processing unit may be at least one processor, a processing circuit, a logic circuit, or the like.

According to an eighth aspect, a communication apparatus is provided. The apparatus includes at least one processor, configured to execute a computer program or instructions stored in a memory, to perform the method provided in any implementation of the first aspect or the second aspect. Optionally, the communication apparatus further includes the memory, configured to store a program.

In an implementation, the apparatus is a processing device.

In another implementation, the apparatus is a chip, a chip system, or a circuit used in a processing device.

According to a ninth aspect, this application provides a processor, configured to perform the method according to the foregoing aspects.

Operations such as sending and obtaining/receiving related to the processor may be understood as operations such as output and receiving or input of the processor, or operations such as sending and receiving performed by a radio frequency circuit and an antenna, unless otherwise specified, or provided that the operations do not contradict actual functions or internal logic of the operations in related descriptions. This is not limited in this application.

According to a tenth aspect, a chip is provided. The chip includes a processor and a communication interface. The processor reads, through the communication interface, instructions stored in a memory, to perform the method provided in any implementation of the first aspect or the second aspect.

Optionally, in an implementation, the chip further includes the memory. The memory stores a computer program or the instructions. The processor is configured to execute the computer program or the instructions stored in the memory. When the computer program or the instructions are executed, the processor is configured to perform the method provided in any implementation of the first aspect or the second aspect.

According to an eleventh aspect, a chip is provided. The chip includes a logic circuit and a communication interface. The communication interface is configured to receive to-be-processed data and/or information, and transmit the to-be-processed data and/or information to the logic circuit. The logic circuit is configured to perform the method provided in any implementation of the first aspect or the second aspect.

### BRIEF DESCRIPTION OF DRAWINGS

FIG. 1 is a diagram of a communication system according to an embodiment of this application;

FIG. 2 is a schematic of a network topology structure applicable to this application;

FIG. 3 is a schematic of a network topology structure applicable to federated learning;

FIG. 4 is a diagram of an example of a model training method according to an embodiment of this application;

FIG. 5 is a diagram of an example in which a first processing node splices at least one first model;

FIG. 6 is a diagram of a possible implementation procedure of a model training method according to an embodiment of this application;

FIG. 7 is a block diagram of a model training apparatus according to an embodiment of this application; and

FIG. 8 is a block diagram of a communication apparatus according to an embodiment of this application.

### DESCRIPTION OF EMBODIMENTS

The following describes technical solutions of embodiments in this application with reference to accompanying drawings.

The technical solutions provided in this application may be applied to various communication systems, for example, a 5th generation (5th generation, 5G) or new radio (new radio, NR) system, a 6th generation (6th generation, 6G) system, a long term evolution (long term evolution, LTE) system, an LTE frequency division duplex (frequency division duplex, FDD) system, and an LTE time division duplex (time division duplex, TDD) system. The technical solutions provided in this application may be further applied to device-to-device (device-to-device, D2D) communication, vehicle-to-everything (vehicle-to-everything, V2X) communication, machine to machine (machine to machine, M2M) communication, machine type communication (machine type communication, MTC), an internet of things (internet of things, IoT) communication system, or another communication system or a future communication system.

For ease of understanding, the following describes nouns or terms in this application.

### 1. Model Processing

The model processing is a process in which one or more models are used as an input, and a corresponding processing operation is performed on the one or more models. In embodiments of this application, a plurality of rounds of model processing may be performed.

### 2. Processing Node

In embodiments of this application, the processing node represents a node that processes at least one first model to generate a common model. The processing performed on the first model may be, for example, aggregation processing, and the aggregation processing can enable the at least one first model to be merged into one common model.

### 3. Participating Node

The participating node represents a node other than a processing node in a current round of model processing. In embodiments of this application, the participating node may be configured to provide a first model to the processing node.

### 4. First Model

The first model represents a model based on which a processing node for a current round of model processing generates a common model of the current round. The first model may be a model generated by a participating node for the current round based on local data, or may be a model generated by a processing node for the current round based on local data, or may be a common model obtained through a previous round of model processing. The first model may be provided by the participating node for the current round, or may be generated by the processing node for the current round.

### 5. Common Model

The common model represents a model generated by processing at least one first model. For a plurality of rounds of model processing, a common model obtained through a last round of model processing may be used as a final output, and further, the final output common model may be used in a corresponding actual task. The common model may also be referred to as a global model.

It should be understood that names of various models and nodes in this application are merely examples for description for ease of understanding of embodiments of this application, and do not constitute any limitation on the protection scope of this application.

For ease of understanding embodiments of this application, a communication system provided in an embodiment of this application is first described in detail with reference to FIG. 1.

FIG. 1 is a diagram of a communication system 100 according to an embodiment of this application. The communication system 100 may include two or more devices (nodes) participating in model training, for example, a device #1 to a device #6 shown in FIG. 1.

The devices participating in the model training may be terminal devices (for example, the device #1 to the device #4), or may be network devices (for example, the device #5 and the device #6).

The terminal device in embodiments of this application may be user equipment, an access terminal, a subscriber unit, a subscriber station, a mobile station, a remote station, a remote terminal, a mobile device, a user terminal, a terminal, a wireless communication device, a user agent, or a user apparatus. The terminal device may alternatively be a cellular phone, a cordless phone, a session initiation protocol (session initiation protocol, SIP) phone, a wireless local loop (wireless local loop, WLL) station, a personal digital assistant (personal digital assistant, PDA), a handheld device having a wireless communication function, a computing device or another processing device connected to a wireless modem, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), or a wireless terminal in a smart grid (smart grid), a wireless terminal in transportation safety (transportation safety), a wireless terminal in a smart city (smart city), a wireless terminal in a smart home (smart home), an in-vehicle device, an uncrewed aerial vehicle device, a wearable device, a terminal device in a future 6G network or a terminal device in a future evolved public land mobile network (public land mobile network, PLMN), or the like. This is not limited in this embodiment of this application. The wearable device is not only a hardware device, but also implements a powerful function through software support, data exchange, and cloud interaction. In a broad sense, intelligent wearable devices include full-featured and large-sized devices that can implement complete or partial functions without depending on smartphones, such as smart watches or smart glasses, and devices that are dedicated to only one type of application function and need to work with other devices such as smartphones, such as various smart bands or smart jewelry used for monitoring physical signs.

The network device in embodiments of this application may be a device configured to communicate with a terminal device. The network device may be a macro base station, a micro base station (also referred to as a small cell), a satellite, a radio network controller (radio network controller, RNC), a NodeB (NodeB, NB), a base station controller (base station controller, BSC), a base transceiver station (base transceiver station, BTS), a home base station (for example, a home evolved NodeB, or a home NodeB, HNB), a baseband unit (baseband unit, BBU), or an AP, a wireless relay node, a wireless backhaul node, a transmission point (transmission point, TP), a transmission and reception point (transmission and reception point, TRP), or the like in a Wi-Fi system; or may be a gNB or a transmission point (TRP or TP) in a 5G (for example, NR) system, or one antenna panel or a group of (including a plurality of antenna panels) antenna panels of a base station in a 5G system; or may be a network node that forms a gNB or a transmission point, such as a distributed unit (distributed unit, DU). Alternatively, the network device may be a relay station, an access point, an in-vehicle device, a wearable device, a network device in a future evolved PLMN network, or the like. This is not limited in this embodiment of this application. A specific technology and a specific device form used by the network device are not limited in this embodiment of this application.

In this embodiment of this application, the network device and the terminal device may be deployed on land, including an indoor device, an outdoor device, a handheld device, or an in-vehicle device; may be deployed on water; or may be deployed on an airplane, a balloon, and a satellite in the air. Scenarios in which the network device and the terminal device are located are not limited in this embodiment of this application.

It should be understood that FIG. 1 is merely a simplified diagram of an example for ease of understanding. A quantity of devices participating in the model training is not limited in this application. For example, the communication system may further include another network device and/or terminal device, which are not shown in FIG. 1.

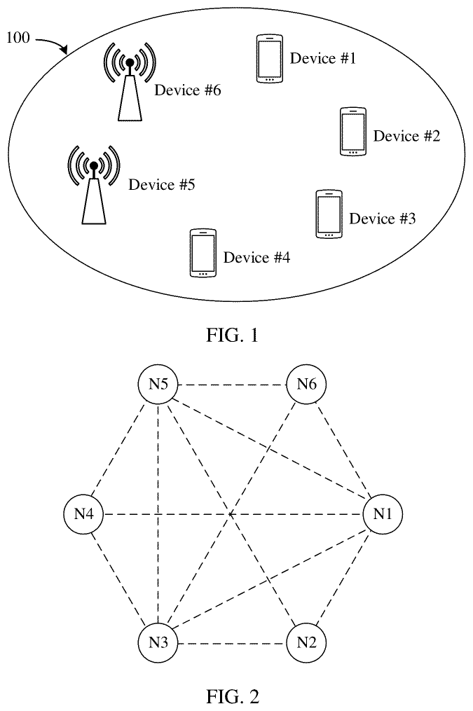

FIG. 2 is a schematic of a possible network topology structure of the foregoing communication system 100. The network topology structure may be further understood as a connection manner between nodes in a network, or may be understood as a connection condition between nodes in a network. The connection manner may be a wired connection manner, or may be a wireless connection manner. This is not limited in this application.

As shown in FIG. 2, the network may include nodes N1 to N6. For example, the nodes N1 to N6 may correspond to the foregoing device #1 to device #6. In the network topology structure shown in FIG. 2, each node can communicate with at least one other node. For example, the node N1 can communicate with N2, N3, N4, N5, and N6, the node N2 can communicate with N1, N3, and N5, and the node N3 can communicate with N1, N2, N4, N5, and N6. Situations in which the nodes N4 to N6 communicate with other nodes are similar to those of the nodes N1 to N3, and details are not described herein again.

It should be understood that the network topology structure shown in FIG. 2 is merely an example for description for ease of understanding of embodiments of this application, and does not constitute any limitation on the protection scope of this application. For example, in another possible network topology structure, any two nodes can communicate with each other.

It should be further understood that the schematic of the network topology structure shown in FIG. 2 may be a schematic of a network topology structure of the network at a moment. During actual application, the network topology structure may further dynamically change.

In the network topology structure shown in FIG. 2, any node may be determined as a processing node, and the processing node may be dynamically changed in a model training process.

Optionally, the processing node is configured to implement at least one of the following functions.

Function 1: Receive a model from at least one node in the network, process the received model, and send a processed model to another node in the network. For example, the processing node may perform aggregation processing on the received model and send an aggregated model to another node in the network.

Function 2: Generate (produce) a model, receive a model from at least one node in the network, and then process the generated model and the received model and send a processed model to another node in the network. For example, the processing node may perform aggregation processing on the generated model and the received model and send an aggregated model to another node in the network.

Correspondingly, the following functional feature of the processing node may be defined.

Polarity (polarity): A node has polarity, which means that the node can use at least one model as an input, and then perform processing (for example, aggregation processing) on the at least one model for output. There is one output model.

The node having polarity may also be referred to as a polarity node (the plurality node).

Optionally, another functional feature of the processing node may be further defined.

Plurality (plurality): A node has plurality, which means that the node can use at least one model as an input, and then perform calculation processing (for example, distillation processing) on each of the at least one model for output. When there are a plurality of input models, there may also be a plurality of output models.

The node having plurality may also be referred to as a plurality node (the plurality node).

With the advent of a big data era, each device generates a large amount of raw data in various forms every day. The data is generated in a form of an “island” and exists in every corner of the world.

To make full use of the data for model training, currently, two typical training architectures are centralized learning (centralized learning, CL) and federated learning (federated learning, FL).

The centralized learning requires that each edge device uniformly transmits local data to a central server, and then the central server performs model training and learning by using the collected data. However, with the development of the era, this architecture is gradually restricted by the following factors.

(1) Edge devices are widely distributed in various regions and corners of the world. These devices will continuously generate and accumulate massive amounts of raw data at a rapid speed. If the central server collects raw data from all edge devices, huge communication losses and computing power requirements are inevitably caused.

(2) With the complexity of actual scenarios, more and more learning tasks need the edge devices to make timely and effective decisions and feedback. The centralized learning involves uploading a large amount of data, which inevitably leads to a high delay. As a result, a model training process cannot satisfy a real-time requirement in an actual task scenario.

(3) In consideration of problems such as industry competition, user privacy security, and complex administrative procedures, centralized integration of data faces increasing constraints. Therefore, a deployment manner of the system tends to store data locally, and the edge device completes local training of a model.

To break the foregoing limitations, a federated learning architecture is proposed.

The federated learning is a distributed machine learning method. In a federated learning process, model training may be performed on a plurality of edge devices by using local data of the plurality of edge devices, and then trained models are uploaded to a central server. The central server may serve as a processing node to aggregate the models from the plurality of edge devices to generate a common model, and deliver the common model to the plurality of edge devices, so that the plurality of edge devices can update the common model based on the local data. The steps are repeatedly performed until the model is converged or a quantity of training rounds reaches a preset upper limit, so that a high-performance machine learning model can be finally obtained.

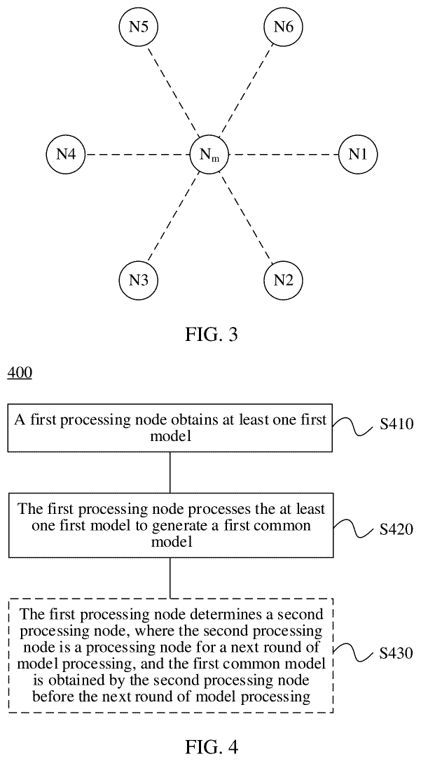

FIG. 3 is a schematic of a network topology structure applicable to federated learning. A network includes a processing node Nₘ and other nodes N1 to N6. For ease of description, the nodes N1 to N6 may be referred to as participating nodes. The processing node may be, for example, a central server, and the participating node may be, for example, an edge device.

As shown in FIG. 3, the network topology structure envisaged by the federated learning is a fixed star structure, and the processing node in a center is indispensable.

For example, the following uses a FedAvg algorithm as an example to describe a general procedure of the federated learning. The FedAvg algorithm is a basic algorithm in the field of federated learning, and the algorithm may include the following steps.

Step 1: A processing node initializes a common model w_{g}⁰, and sends the common model wo to all participating nodes.

Step 2: In a (t∈[1,T])^{th} round, the participating node k∈[1,K] trains the received common model w_{g}^{t-1} in E epochs based on a local dataset [symbol] ₖ, in other words, performs E times of iterative updates, to obtain a local training model wₖ^{t}; and reports the local training model wₖ^{t} to the processing node, where an initial value of t is 1.

Step 3: The processing node performs aggregation processing on all or some of received models to obtain a common model w_{g}^{t}.

For example, the processing node may obtain the common model w_{g}^{t} by calculating a weighted average value of parameters of all or some of the models. Specifically, it is assumed that a set of participating nodes that uploads a local training model in a t^{th} round is [symbol] ^{t}, and the processing node may obtain the common model w_{g}^{t} by using the following rule:

$${w}_{g}^{t} = {\sum }_{k ∈ {𝒮}^{t}} \frac{{D}_{k} {w}_{k}^{t}}{{\sum }_{k ∈ {𝒮}^{t}} {D}_{k}}$$

where Dₖ represents a quantity of samples of participating nodes whose index numbers are k in the set [symbol] ^{t}. Then, the processing node may send the obtained common model w_{g}^{t} to all the participating nodes, to perform a new round of training.

Step 4: Increase a value of t by 1, and return to step 2. Repeat step 2 and step 3 until the model is converged or a quantity of training rounds reaches a preset upper limit.

In a current federated learning architecture, the processing node configured to generate the common model is fixed. However, in different application scenarios, using the fixed node as the processing node may not be an optimal solution. For example, with a change of a network topology structure and a change of data generated by each node, a more preferable processing node may appear.

Therefore, this application provides a model training method and apparatus. In the method, before a next round of model processing, a processing node for the next round of model processing may be determined based on an actual requirement, to adapt to a change of an application scenario. In other words, in the model training method provided in this application, the processing node may dynamically change in a model training process. In this way, based on the model training method provided in this application, before the next round of model processing, the processing node for the next round of model processing may be determined based on an actual requirement. When the processing node for the next round of model processing and a processing node for a current round of model processing are different processing nodes, the processing node for the current round of model processing may send a generated common model to the processing node for the next round of model training. Because the processing node for the next round of model processing may be randomly specified based on an actual requirement, the common model can be continuously transmitted between different nodes in a network through a plurality of rounds of model processing. For example, this architecture may also be considered as a “model-follow-data (model-follow-data)” architecture.

The following describes in detail the model training method provided in embodiments of this application with reference to the accompanying drawings. The model training method provided in embodiments of this application may be applied to the communication system shown in FIG. 1 and the network topology structure shown in FIG. 2.

FIG. 4 is a diagram of an example of a model training method according to an embodiment of this application. The method 400 may include S410 to S430.

S410: A first processing node obtains at least one first model.

That the first processing node obtains the first model may also be understood as that the first processing node obtains related information of the first model. For example, the first processing node may obtain one or more pieces of the following information about the first model: a parameter set of the first model, a structure of a neural network corresponding to the first model, and an operation rule of parameters of the first model. For example, the parameter set of the first model may include a training weight of the neural network corresponding to the first model.

For brevity, in this embodiment of this application, a structure of a neural network corresponding to a model may be briefly referred to as a network structure of the model.

Optionally, related information of the model is described in one or more of the following forms: a model diagram, a model parameter, a model table, a model algorithm, a database, and the like. This is not limited in this application.

In S410, the first processing node may obtain the at least one first model in at least one of the following manners.

In a first possible manner, the first processing node may receive the first model from at least one participating node, in other words, the at least one first model may include the first model from the at least one participating node. The architecture shown in FIG. 2 is used as an example. For example, when the first processing node is the node N1 in FIG. 2, the node N1 may receive a first model generated by at least one of the nodes N2 to N6 by using a local dataset.

Optionally, based on the first possible manner, before the first processing node receives

the first model from the at least one participating node, the method 400 may further include: The first processing node sends indication information to the at least one participating node, where the indication information may indicate the at least one participating node to send (upload) the first model of the at least one participating node to the first processing node.

In a possible case, the participating node has generated the first model before receiving the indication information, in other words, the participating node has stored the first model locally. In this case, if the participating node receives the indication information from the first processing node, the participating node may upload the first model to the first processing node based on an indication of the indication information.

In another possible case, the participating node does not generate the first model when receiving the indication information, in other words, the participating node does not store the first model locally. In this case, if the participating node needs to participate in a model training task, the participating node may generate the first model after receiving the indication information from the first processing node, and then upload the generated first model to the first processing node.

Optionally, the indication information further indicates a manner in which the first processing node generates a first common model.

For example, the first processing node generates the first common model in Manner 1 and/or Manner 2 (Manner 1 and Manner 2 of generating the first common model are described below, and details are not described herein), and the indication information may carry a tag corresponding to Manner 1 or Manner 2. Therefore, the participating node that receives the indication information may include the tag in the information about the first model, and then send the first model (or the information about the first model) to the first processing node. In this way, the first processing node can determine, based on the tag carried in the information about the first model, to process the first model in Manner 1 and/or Manner 2, to generate the first common model.

In a second possible manner, the first processing node may generate the first model, in other words, the at least one first model may include the first model generated by the first processing node. The architecture shown in FIG. 2 is used as an example. For example, when the first processing node is the node N1 in FIG. 2, the node N1 may generate a first model by using a local dataset.

Based on the foregoing two possible manners, the first processing node may receive the first model from the at least one participating node, or may generate the first model locally, so that the first processing node can make full use of a first model of each node in a network to perform model training, to generate a common model with better performance.

Optionally, the at least one first model includes a second common model, and the second common model is a common model obtained through a previous round of model processing. For example, if the first processing node is a processing node for a t^{th} (where t is greater than 1) round of model processing, in addition to the first model from the at least one participating node and/or the first model generated by the first processing node, the first model may further include a common model obtained through a previous round (a (t−1)^{th} round) of model processing. Therefore, the first processing node may optimize the common model based on the common model obtained in the previous round, to further improve performance of the common model.

It is assumed that the processing node for the previous round of model processing is a third processing node.

In a possible case, the third processing node and the first processing node are different processing nodes. In this case, the first processing node may receive the second common model from the third processing node, in other words, the second common model may be received from the third processing node.

In another possible case, the third processing node and the first processing node are a same processing node, in other words, the processing node for the previous round of model processing and a processing node for a current round of model processing are a same processing node. In this case, the second common model may be a common model generated by the first processing node in the previous round of model processing.

S420: The first processing node processes the at least one first model to generate the first common model.

In this embodiment, the first processing node may process the obtained at least one first model to generate the first common model.

For example, the first processing node may perform aggregation processing on the at least one first model to generate the first common model. The aggregation processing can enable the at least one first model to be merged into a common model with better performance.

For example, a manner in which the first processing node processes the at least one first model to generate the first common model may include at least one of the following manners.

Manner 1: The first processing node may process parameters of the at least one first model to generate the first common model.

Manner 2: The first processing node may splice the at least one first model to generate the first common model.

The following separately describes the foregoing Manner 1 and Manner 2.

### Manner 1

In Manner 1, the first processing node may process the parameters of the at least one first model to generate the first common model.

In a possible implementation, the first processing node may generate the first common model in a manner of performing average processing on the parameters of the at least one first model, where a value of a parameter of the first common model is an average value of the parameters of the at least one first model.

For example, the at least one first model includes a first model #1 and a first model #2. Parameters of the first model #1 are, for example, [a1 b1 c1], and parameters of the first model #2 are, for example, [a2 b2 c2]. In this case, a value of a parameter of a generated common model is [(a1+a2)/2 (b1+b2)/2 (c1+c2)/2].

In some scenarios, the average processing may be weighted average processing, in other words, the first common model is generated in a manner of performing the weighted average processing on the parameters of the at least one first model. In this case, the value of the parameter of the generated first common model is a weighted average value of the parameters of the at least one first model.

In another possible implementation, the first processing node may alternatively generate the first common model in a manner of calculating another statistical value of the parameters of the at least one first model. For example, the first processing node may generate the first common model in a manner of calculating a median of the parameters of the at least one first model. In this case, a value of a parameter of the generated first common model is the median of the parameters of the at least one first model.

Optionally, in Manner 1, the at least one first model has a same network structure.

Optionally, to enable the at least one first model to have the same network structure, the method 400 further includes: The first processing node performs distillation processing on the at least one first model, where the distillation processing may enable the at least one first model to have the same network structure. In this way, it can be more convenient for the first processing node to process the parameters of the at least one first model.

Optionally, the distillation processing further enables the at least one first model to have a same quantity of parameters of the model and/or a same operation rule.

For example, the distillation processing may be for reducing a quantity of parameters of the model, or may be for increasing a quantity of parameters of the model.

In a possible implementation, the first processing node may determine an expected quantity of parameters of the first model based on a computing capability of the first processing node, so that the quantity of parameters of the first model may be consistent with the expected quantity of parameters of the first model through the distillation processing. For example, if the computing capability of the first processing node is strong, the first model may have a large quantity of parameters through the distillation processing, to improve performance of the first model and the generated common model. For another example, if the computing capability of the first processing node is weak, the first model may have a small quantity of parameters through the distillation processing, to improve model training efficiency. In this way, the quantity of parameters of the first model can adapt to the computing capability of the first processing node.

It should be noted that the foregoing distillation processing may be implemented by using any model distilling (model distilling) algorithm. This is not limited in this application.

Optionally, the distillation processing in this embodiment may be alternatively replaced with another algorithm that can enable models to have a same network structure, for example, may be replaced with another model compression (model compression) algorithm or model dilatation (model dilatation) algorithm that can enable the models to have the same network structure.

### Manner 2

In Manner 2, the first processing node may splice the at least one first model to generate the first common model.

Network structures of the at least one first model may be the same or may be different.

That the network structures of the models are different may also be understood as that, in neural networks corresponding to the models, quantities of network layers are different, and/or a quantity of nodes included at a layer is different.

For example, the first processing node may separately splice an input end and an output end of the at least one first model, to implement splicing of the at least one first model.

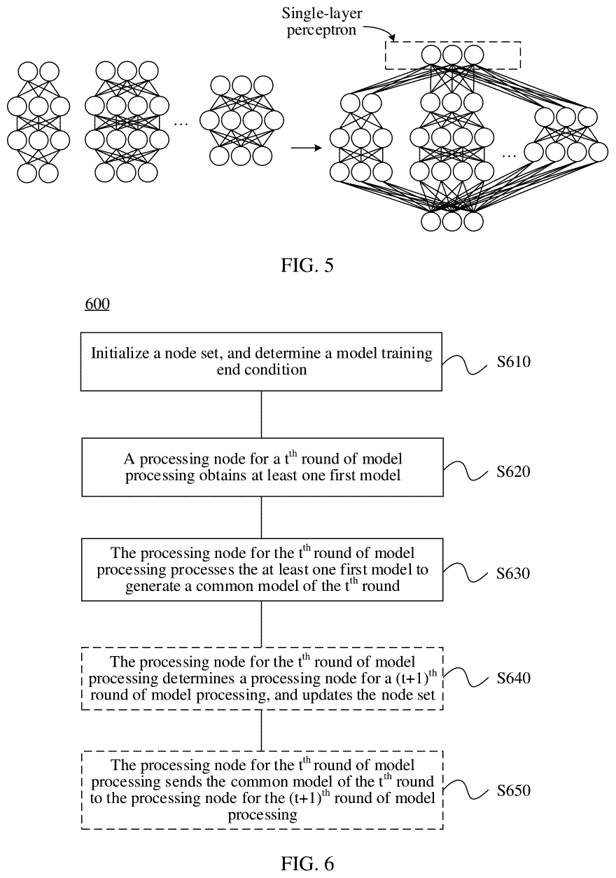

With reference to FIG. 5, the following describes a possible implementation in which the first processing node splices the at least one first model.

FIG. 5 is a diagram of an example in which the first processing node splices the at least one first model. As shown in FIG. 5, the first processing node may connect the input end of the at least one first model by using a single-layer perceptron, and combine the output end of the at least one first model into a single-layer output, to implement splicing of the at least one first model.

It should be noted that, in this application, a quantity of nodes included in the single-layer perceptron and a quantity of nodes existing after output end combination are not limited. For example, as shown in FIG. 5, the single-layer perceptron and the combined output end may respectively include three nodes.

In an implementation, connecting the input end of the at least one first model by using the single-layer perceptron may mean that all nodes of the single-layer perceptron are separately connected to all nodes of the input end of the at least one first model. As shown in FIG. 5, the three nodes of the single-layer perceptron may be separately connected to all nodes of the input end of the at least one first model.

In an implementation, combining the output end of the at least one first model into the single-layer output may mean that the single-layer output is used to replace an original output of the at least one first model, and all nodes in the single-layer output are separately connected to all nodes at an upper layer. As shown in FIG. 5, the three nodes in the single-layer output may be separately connected to all nodes at the upper layer.

It should be understood that the foregoing manner of separately splicing the input end and the output end of the at least one first model is an example. Apparently, the input end and the output end of the at least one first model may be separately spliced in another manner. For example, in another possible implementation, the input end of the at least one first model may be combined into a single-layer output, and the output end of the at least one first model are spliced by using the single-layer perceptron. For another example, the input end and the output end of the at least one first model may be separately combined into a single-layer output. For another example, the input end and the output end of the at least one first model may be spliced by using the single-layer perceptron separately. For another example, the single-layer perceptron may be replaced with a multi-layer perceptron, and the single-layer output may be replaced with a multi-layer output. This is not limited in this application.

Optionally, the first processing section further adjusts a structure of a spliced model. For example, the first processing section may add a layer to or delete a layer from the structure of the spliced model, or the first processing section may add a node to or delete a node from the structure of the spliced model. This is not limited in this application.

It should be understood that after completing splicing the at least one first model, the first processing node may train, based on local data, the spliced model by using a reverse transfer algorithm, to generate the first common model.

Optionally, if the first common model is generated in Manner 2, the method 400 further includes: Perform a model pruning operation on the generated first common model. For example, some redundant layers or nodes in the first common model may be deleted through the model pruning operation, so that the first common model is more suitable for transmission in a communication network, to reduce communication load.

It should be noted that the model pruning operation may be implemented by using any model pruning algorithm. This is not limited in this application.

Optionally, in this embodiment of this application, the first processing node further determines, based on a computing capability of the first processing node, to process all or some of the models in the obtained at least one first model. For example, when the computing capability of the first processing node is insufficient, the first processing node may selectively process some of the models in the obtained at least one first model, and does not need to process all the models, so that a quantity of models processed by the first processing node can match the computing capability of the first processing node.

Optionally, if the first processing node is a processing node for any round of model processing before a last round of model processing, the method 400 includes S430.

S430: The first processing node determines a second processing node, where the second processing node is a processing node for a next round of model processing, and the first common model is obtained by the second processing node before the next round of model processing.

In this embodiment, before the next round of model processing, the first processing node may determine an appropriate processing node for the next round of model processing, so that different application scenarios can be adapted, to improve model training performance.

The first processing node and the second processing node may be a same processing node, or may be different processing nodes.

In a possible case, the first processing node and the second processing node are the different processing nodes. In this case, the method 400 may further include: The first processing node sends the first common model to the second processing node before the next round of model processing, so that the first common model can be obtained by the second processing node before the next round of model processing.

According to the method in this embodiment, because the second processing node may be randomly specified by the first processing node, the common model can be continuously transmitted between different nodes in the network through a plurality of rounds of model processing. In addition, after generating the common model, the processing node for the current round of model processing may send the common model to the processing node for the next round of model processing, and does not need to deliver the common model to all participating nodes. Therefore, communication overheads are reduced.

In another possible case, the first processing node and the second processing node are the same processing node. In other words, the processing node for the current round of model processing and the processing node for the next round of model processing are the same processing node. In this case, the first processing node may not need to send the first common model to the second processing node.

For example, the second processing node may be determined in at least one of the following manners.

Manner 1: The second processing node is determined based on an indication of the first common model.

Manner 2: The second processing node is determined based on one or more pieces of the following information: a network topology structure, data quality of the second processing node, and a computing capability of the second processing node.

The following separately describes the foregoing Manner 1 and Manner 2.

### Manner 1

In Manner 1, the first processing node may determine the second processing node based on the indication of the first common model.

In an example, the first common model may indicate the second processing node to the first processing node based on a feature of the first common model. For example, the feature of the first common model may be a quantity of parameters of the first common model. In a possible case, the quantity of parameters of the first common model is large. Therefore, it is expected that the first common model is processed by a node with a strong computing capability. In this case, the first common model may indicate the first processing node to determine a node with the strong computing capability as the second processing node. For another example, the feature of the first common model may be a current functional feature of the first common model. For example, a current function of the first common model is a classification function. Therefore, if a node in the network has local data used for a classification learning task. In this case, the first common model may indicate the first processing node to determine the node as the second processing node.

In another example, the first common model may indicate the second processing node to the first processing node based on the parameter of the first common model. For example, the parameter of the first common model includes corresponding routing information, and the routing information may indicate the processing node for the next round of model processing, so that the first processing node can determine the second processing node based on the routing information in the first common model.

For example, the routing information may be preconfigured information, or may be information dynamically configured in a model training process. This is not limited in this application.

The second processing node is determined in the foregoing Manner 1, which helps determine, for the first common model, the second processing node that matches the feature or a requirement of the first common model, and further helps improve model training performance.

### Manner 2

In Manner 2, the second processing node may be determined based on one or more pieces of the following information: the network topology structure, the data quality of the second processing node, and the computing capability of the second processing node.

In an example, the second processing node may be determined based on the network topology structure. For example, if a node is in a more advantageous position in the network topology structure, the node may be determined as the second processing node.

For example, when the network topology structure is shown in FIG. 2, the nodes N1, N3, and N5 may separately communicate with five nodes in the network, and the nodes N2, N4, and N6 may separately communicate with three nodes in the network. In other words, compared with the nodes N2, N4, and N6, it is convenient for the nodes N1, N3, and N5 to communicate with more nodes. Therefore, the nodes N1, N3, or N5 may be determined as the second processing node.

The second processing node is determined based on the network topology structure, which helps improve transmission efficiency of the model in the network.

In another example, the second processing node may be determined based on the data quality of the second processing node. For example, if data quality of a node in the network is high, the node may be determined as the second processing node. For another example, if data quality of nodes in an area in the network is high, a node may be determined from the area as the second processing node.

In an optional embodiment, before a round of model processing is started, if data quality of nodes in an area in the network is high, a node in the area may be determined as the second processing node, and another node in the area is used as the participating node, to complete the round of model processing.

Optionally, the data quality of the second processing node is quantized in any one of the following manners.

In an optional manner, model training may be performed based on local data of the second processing node, so that the data quality of the second processing node can be quantized by detecting convergence time of the model training and accuracy of completing a task during model derivation.

In another optional manner, the data quality of the second processing node may be quantized by calculating whether data of the second processing node complies with agreed data distribution.

The second processing node is determined based on the data quality of the second processing node, which helps improve performance of a common model generated by the second processing node.

In still another example, the second processing node may be determined based on the computing capability of the second processing node. For example, computing capabilities of nodes may be compared, to determine a node with a stronger computing capability as the second processing node.

The second processing node is determined based on the computing capability of the second processing node, which helps improve model training efficiency.

It should be understood that, when the second processing node is determined, one of the three pieces of information may be separately considered based on an actual task requirement, or any two or more pieces of information may be comprehensively considered. This helps determine an appropriate second processing node for a specific application scenario, to improve model training performance.

It should be further understood that, when the second processing node is determined, either Manner 1 or Manner 2 may be used, or the second processing node may be determined with reference to both Manner 1 and Manner 2. This is not limited in this application.

It should be further understood that, in some scenarios, the first processing node may further determine the second processing node based on preconfigured information. For example, the preconfigured information may be sent to the first processing node by using another device, or the first processing node may pre-store the preconfigured information. This is not limited in this application.

In the model training process, a preferred processing node may change with a change of the network topology structure and a change of data generated by each node. Therefore, in this embodiment, the first processing node determines an appropriate processing node for the next round of model processing, so that a change of an application scenario can be better adapted, to improve model training performance.

Optionally, if the first processing node is a processing node for a last round of model processing, S430 does not need to be performed. In this case, the at least one first model obtained by the first processing node includes the common model obtained through the previous round of model processing, so that the first processing node may perform final model processing based on the common model obtained through the previous round of model processing, to obtain a high-performance common model.

Optionally, after the last round of model processing is completed, the method 400 further includes: The processing node for the last round of model processing sends, to another node (for example, the at least one participating node), a common model obtained through the last round of model processing, so that the another node can use the common model obtained through the last round of model processing in a corresponding actual task.

With reference to FIG. 4 and FIG. 5, the foregoing describes the model training method provided in embodiments of this application. For ease of understanding embodiments of this application, the following describes, with reference to FIG. 6, a possible implementation procedure of a model training method provided in an embodiment of this application.

As shown in FIG. 6, the implementation procedure may include the following steps.

S610: Initialize a node set, and determine a model training end condition.

The model training end condition may include at least one of the following: a quantity of rounds of model processing reaches an upper limit T of a quantity of rounds, and a generated common model satisfies a model convergence condition (for example, when the generated common model satisfies a performance requirement, the model converges). T is an integer greater than or equal to 1.

In a possible implementation, when either of the foregoing two conditions is satisfied, the model training ends.

In another possible implementation, when both the foregoing two conditions are satisfied, the model training ends.

Optionally, S610 further includes: Determine the upper limit T of the quantity of rounds and/or the model convergence condition.

Before a first round of model processing starts, nodes that participate in the first round of model training may be determined from nodes that satisfy a network connection condition, and these nodes form an initial node set.

The node set may include a processing node set and a participating node set. The processing node set may include a processing node for the first round of model processing, and the participating node set may include a node other than the processing node in the node set.

In an optional embodiment, S610 may further include: Determine a quantity m of times of additional optimization processing on the common model after each round of model processing.

According to the method in this embodiment, after each round of model processing, an optimization algorithm may be further used to perform m times of optimization processing on a common model generated in the round. For example, after each round of model processing, the m times of optimization processing may be further performed, by using a federated learning method or another method, on the common model generated in the round, to further improve performance of the common model.

S620: A processing node for a t^{th} round of model processing obtains at least one first model.

In an example, the processing node for the t^{th} round of model processing may obtain the at least one first model by receiving the first model from at least one participating node, in other words, the at least one first model may include the first model from the at least one participating node. The at least one participating node belongs to the participating node set.

In a possible implementation, the processing node for the t^{th} round of model processing may send indication information to the at least one participating node, so that after receiving the indication information, the at least one participating node may upload the first model of the at least one participating node to the processing node for the t^{th} round of model processing based on an indication of the indication information. The first model may be generated before the participating node receives the indication information, or may be generated after the participating node receives the indication information. This is not limited.

For descriptions of the indication information, refer to S410 in the foregoing method embodiment. To avoid repetition, details are not described herein again.

In another example, the processing node for the t^{th} round of model processing may alternatively obtain the at least one first model in a manner of generating a first model by the processing node.

Optionally, when t is greater than 1, the at least one first model includes a common model obtained through a (t−1)^{th} round of model processing.

S630: The processing node for the t^{th} round of model processing processes the at least one first model to generate a common model of the t^{th} round.

Optionally, the processing node for the t^{th} round of model processing generates the common model of the t^{th} round in at least one of Manner 1 or Manner 2 in S420 in the foregoing method embodiment. For descriptions of Manner 1 and Manner 2, refer to S420 in the foregoing method embodiment. To avoid repetition, details are not described herein again.

Optionally, if the processing section for the t^{th} round of model processing is a processing node for any round of model processing before a last round of model processing, the implementation procedure includes S640.

S640: The processing node for the t^{th} round of model processing determines a processing node for a (t+1)^{th} round of model processing, and updates the node set.

An updated node set may include nodes that participate in the (t+1)^{th} round of model training. Correspondingly, an updated processing node set may include the processing node for the (t+1)^{th} round of model processing, and an updated participating node set may include a node other than the processing node for the (t+1)^{th} round of model processing in a (t+1)^{th} round of node sets.

Optionally, if the processing node for the t^{th} round of model processing and the processing node for the (t+1)^{th} round of model processing are different processing nodes, the implementation procedure further includes S650.

S650: The processing node for the t^{th} round of model processing sends the common model of the t^{th} round to the processing node for the (t+1)^{th} round of model processing.

Therefore, the processing node for the (t+1)^{th} round of model processing may further optimize the common model based on the common model of the t^{th} round, to improve performance of the common model.

Optionally, if the t^{th} round of model processing is a last round of model processing, S640 and S650 do not need to be performed. In this case, if t is greater than 1 (in other words, the last round of model processing is not the first round of model processing), the at least one first model obtained by the processing node for the t^{th} round of model processing includes the common model obtained through the (t−1)^{th} round of model processing. Therefore, the processing node for the t^{th} round of model processing may perform final model processing based on the common model obtained through the (t−1)^{th} round of model processing, to obtain a high-performance common model.

After a plurality of rounds of model processing (optimization learning) until the model training end condition is satisfied, the high-performance common model can be output.

It may be understood that the examples in FIG. 4 to FIG. 6 in embodiments of this application are merely intended to help a person skilled in the art understand embodiments of this application, but are not intended to limit embodiments of this application to specific scenarios in the examples. A person skilled in the art can apparently make various equivalent modifications or changes based on the examples shown in FIG. 4 to FIG. 6, and such modifications or changes also fall within the scope of embodiments of this application.

It may be further understood that some optional features in embodiments of this application may be independent of other features in some scenarios, or may be combined with other features in some scenarios. This is not limited.

It may be further understood that the solutions in embodiments of this application may be appropriately combined for use, and explanations or descriptions of terms in the embodiments may be mutually referenced or explained in the embodiments. This is not limited.

It may be further understood that various numeric sequence numbers in embodiments of this application do not mean execution sequences, but are merely for differentiation for ease of description, and therefore should not constitute any limitation on an implementation process of embodiments of this application.

It may be further understood that in embodiments of this application, numbers such as first, second, #1, and #2 are merely used for differentiation for ease of description, and are not used to limit the scope of embodiments of this application.

It may be further understood that names of information transmitted between communication apparatuses in embodiments of this application do not limit the protection scope of embodiments of this application.

It may be understood that the term “and/or” in this specification describes only an association relationship between associated objects and represents that three relationships may exist. For example, A and/or B may represent the following three cases: Only A exists, both A and B exist, and only B exists. In addition, the character “/” in this specification generally represents an “or” relationship between the associated objects.

It may be further understood that, in the foregoing method embodiments, methods and operations implemented by the processing node may also be implemented by a component (for example, a chip or a circuit) of the processing node. This is not limited.

Corresponding to the methods provided in the foregoing method embodiments, an embodiment of this application further provides a corresponding apparatus. The apparatus includes a corresponding module configured to perform the foregoing method embodiments. The module may be software, hardware, or a combination of software and hardware. It may be understood that the technical features described in the method embodiments are also applicable to the following apparatus embodiments.

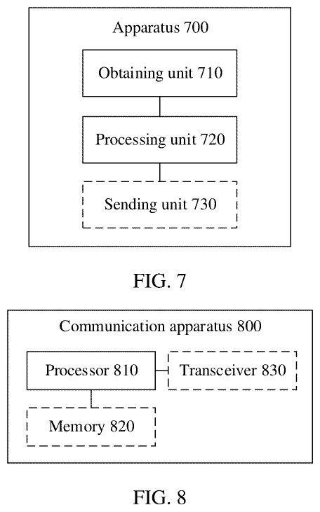

FIG. 7 is a block diagram of a model processing apparatus 700 according to an embodiment of this application. The apparatus 700 includes an obtaining unit 710 and a processing unit 720. The obtaining unit 710 may be configured to implement a corresponding obtaining function, for example, obtain at least one first model. The processing unit 720 may be configured to implement a corresponding processing function, for example, process the at least one first model to generate a first common model.

Optionally, the apparatus 700 further includes a sending unit 730, and the sending unit 730 may be configured to implement a corresponding communication function. The sending unit 730 may also be referred to as a communication interface or a communication unit.

Optionally, the apparatus 700 further includes a storage unit. The storage unit may be configured to store instructions and/or data. The processing unit 720 may read the instructions and/or the data in the storage unit, so that the apparatus implements actions of the processing device (for example, the first processing node) in the foregoing method embodiments.

In a design, the apparatus 700 may be the processing device in the foregoing embodiments, or may be a component (such as a chip) of the processing device. For example, the apparatus 700 may implement steps or procedures performed by the first processing node in the foregoing method embodiments. The obtaining unit 710 may be configured to perform obtaining-related operations of the first processing node in the foregoing method embodiments. The processing unit 720 may be configured to perform processing-related operations of the first processing node in the foregoing method embodiments. The sending unit 730 may be configured to perform sending-related operations of the first processing node in the foregoing method embodiments. When the apparatus 700 is the first processing node, the sending unit 730 may be a transceiver or an input/output interface. Optionally, the transmitter may be a transceiver circuit. Optionally, the input/output interface may be an input/output circuit. The processing unit 720 may be at least one processor. When the apparatus 700 is a chip, a chip system, or a circuit in the first processing node, the sending unit 730 may be an input/output interface, an interface circuit, an input/output circuit, a pin, a related circuit, or the like on the chip, the chip system, or the circuit, and the processing unit 720 may be at least one processor, a processing circuit, a logic circuit, or the like.

In a possible implementation, the obtaining unit 710 is configured to obtain the at least one first model. The processing unit 720 is configured to process the at least one first model to generate the first common model. The processing unit 720 is further configured to determine a second processing node, where the second processing node is a processing node for a next round of model processing, and the first common model is obtained by the second processing node before the next round of model processing.

Optionally, the apparatus 700 and the second processing node are different processing nodes. The apparatus 700 further includes the sending unit 730. The sending unit 730 is configured to send the first common model to the second processing node. Optionally, the obtaining unit 710 and the sending unit 730 are a same unit, or the obtaining unit 710 includes the sending unit 730.

Optionally, the apparatus 700 and the second processing node are a same processing node.

Optionally, the processing unit 720 is further configured to determine the second processing node based on an indication of the first common model.

Optionally, the obtaining unit 710 is further configured to receive the first model from at least one participating node.

Optionally, the apparatus 700 further includes the sending unit 730. The sending unit 730 is configured to send indication information to the at least one participating node, where the indication information indicates the at least one participating node to send the first model of the at least one participating node to the apparatus 700. Optionally, the obtaining unit 710 and the sending unit 730 are a same unit, or the obtaining unit 710 includes the sending unit 730.

Optionally, the obtaining unit 710 is further configured to generate the first model of the apparatus 700. Optionally, the obtaining unit 710 and the processing unit 720 are a same unit, or the obtaining unit 710 includes the processing unit 720.

Optionally, the processing unit 720 is further configured to perform aggregation processing on the at least one first model to generate the first common model.

Optionally, the processing unit 720 is further configured to process parameters of the at least one first model to generate the first common model.

Optionally, the processing unit 720 is further configured to perform average processing on the parameters of the at least one first model to generate the first common model, where a value of a parameter of the first common model is an average value of the parameters of the at least one first model.

Optionally, the at least one first model has a same network structure.

Optionally, the processing unit 720 is further configured to perform distillation processing on the at least one first model, where the distillation processing enables the at least one first model to have the same network structure.

Optionally, the processing unit 720 is further configured to splice the at least one first model to generate the first common model.

Optionally, the at least one first model includes a second common model, and the second common model is a common model obtained through a previous round of model processing.

Optionally, the obtaining unit 710 is further configured to receive the second common model from a third processing node, where the third processing node is a processing node for the previous round of model processing.

Optionally, the second processing node is determined based on one or more pieces of the following information: a network topology structure, data quality of the second processing node, and a computing capability of the second processing node.

Optionally, the obtaining unit 710 includes the sending unit 730 and/or the processing unit 720; or the obtaining unit 710 and the sending unit 730 or the processing unit 720 are a same unit; or the obtaining unit 710 and the sending unit 730 or the processing unit 720 are integrated into a same unit. Optionally, the processing unit 720 may be a processor, a processing circuit, a logic circuit, or the like. The sending unit 730 may be a transmitter, a transmitter circuit, a transceiver, a transceiver circuit, an input/output interface, a circuit, or the like.

It should be understood that a specific process in which the units perform the foregoing corresponding steps is described in detail in the foregoing method embodiments. For brevity, details are not described herein.

It should be understood that the apparatus 700 herein is embodied in a form of a functional unit. The term “unit” herein may refer to an application-specific integrated circuit (application-specific integrated circuit, ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus 700 may be specifically the first processing node in the foregoing embodiments, and may be configured to perform procedures and/or steps corresponding to the first processing node in the foregoing method embodiments. To avoid repetition, details are not described herein again.

The apparatus 700 in the foregoing solutions has a function of implementing corresponding steps performed by the processing device (for example, the first processing node) in the foregoing methods. The function may be implemented by hardware, or may be implemented by hardware executing corresponding software. The hardware or software includes one or more modules corresponding to the foregoing functions. For example, the sending unit may be replaced with a transmitter, and other units such as the processing unit may be replaced with a processor, to respectively perform sending operations and processing-related operations in the method embodiments.

In addition, the sending unit 730 may be a transceiver circuit, and the processing unit 710 may be a processing circuit.

It should be noted that the apparatus in FIG. 7 may be the device in the foregoing embodiments, or may be a chip or a chip system, for example, a system-on-chip (system-on-chip, SoC). The sending unit may be an input/output circuit or a communication interface. The processing unit is a processor, a microprocessor, or an integrated circuit integrated on the chip. This is not limited herein.

As shown in FIG. 8, an embodiment of this application provides another communication apparatus 800. The apparatus 800 includes a processor 810. The processor 810 is configured to execute a computer program or instructions stored in a memory 820, or read data/signaling stored in a memory 820, to perform the methods in the foregoing method embodiments. Optionally, there are one or more processors 810.

Optionally, as shown in FIG. 8, the apparatus 800 further includes the memory 820. The memory 820 is configured to store the computer program or the instructions and/or data. The memory 820 and the processor 810 may be integrated, or may be disposed separately. Optionally, there are one or more memories 820.

Optionally, as shown in FIG. 8, the apparatus 800 may further include a transceiver 830. The transceiver 830 is configured to receive and/or send signals. For example, the processor 810 is configured to control the transceiver 830 to receive and/or send the signals.

In a solution, the apparatus 800 is configured to implement operations performed by the processing device (for example, the first processing node) in the foregoing method embodiments.

For example, the processor 810 is configured to execute the computer program or the instructions stored in the memory 820, to implement related operations of the processing device (for example, the first processing node) in the foregoing method embodiments.

It should be understood that, the processor mentioned in embodiments of this application may be a central processing unit (central processing unit, CPU), and may further be another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or a transistor logic device, a discrete hardware component, or the like. The general-purpose processor may be a microprocessor, or the processor may be any conventional processor or the like.

It should be further understood that the memory mentioned in embodiments of this application may be a volatile memory and/or a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM). For example, the RAM may be used as an external cache. By way of example but not limitation, the RAM includes a plurality of forms, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is the general-purpose processor, the DSP, the ASIC, the FPGA or the another programmable logic device, the discrete gate or the transistor logic device, or the discrete hardware component, the memory (a storage module) may be integrated into the processor.

It should further be noted that the memory described herein is intended to include, but is not limited to, these and any other appropriate type of memory.

An embodiment of this application further provides a computer-readable storage medium. The computer-readable storage medium stores computer instructions used to implement the method performed by the device in the foregoing method embodiments.

For example, when the computer program is executed by a computer, the computer is enabled to implement the method performed by the processing device (for example, the first processing node) in the foregoing method embodiments.

An embodiment of this application further provides a computer program product, including instructions. When the instructions are executed by a computer, the method performed by the processing device (for example, the first processing node) in the foregoing method embodiments is implemented.

For explanations and beneficial effects of related content in any one of the apparatuses provided above, refer to the corresponding method embodiments provided above. Details are not described herein again.

In the several embodiments provided in this application, it should be understood that the disclosed apparatus and method may be implemented in another manner. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

All or some of the foregoing embodiments may be implemented by using software, hardware, firmware, or any combination thereof. When the software is used to implement the embodiments, all or some of the embodiments may be implemented in a form of a computer program product. The computer program product includes one or more computer instructions. When the computer program instructions are loaded and executed on a computer, all or some of the procedures or functions according to embodiments of this application are generated. The computer may be a general-purpose computer, a dedicated computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (solid state disk, SSD)), or the like. For example, the usable medium may include but is not limited to any medium that can store program code, for example, a USB flash drive, a removable hard disk, a read-only memory (read-only memory, ROM), a random access memory (random access memory, RAM), a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A model training method, comprising:
obtaining, by a first processing node, at least one first model;
processing, by the first processing node, the at least one first model to generate a first common model; and
determining, by the first processing node, a second processing node, wherein the second processing node is a processing node for a next round of model processing, and the first common model is obtained by the second processing node before the next round of model processing.

2. The method according to claim 1, wherein the first processing node and the second processing node are different processing nodes, and the method further comprises:
sending, by the first processing node, the first common model to the second processing node.

3. The method according to claim 1, wherein
the first processing node and the second processing node are a same processing node.

4. The method according to claim 1, wherein the determining, by the first processing node, a second processing node comprises:
determining, by the first processing node, the second processing node based on an indication of the first common model.

5. The method according to claim 1, wherein the obtaining, by a first processing node, at least one first model comprises:
receiving, by the first processing node, the first model from at least one participating node.

6. The method according to claim 5, wherein before the receiving, by the first processing node, the first model from at least one participating node, the method further comprises:
sending, by the first processing node, indication information to the at least one participating node, wherein the indication information indicates the at least one participating node to send the first model of the at least one participating node to the first processing node.

7. The method according to claim 1, wherein the obtaining, by a first processing node, at least one first model comprises:
generating, by the first processing node, the first model of the first processing node.

8. The method according to claim 1, wherein the processing, by the first processing node, the at least one first model to generate a first common model comprises:
performing, by the first processing node, aggregation processing on the at least one first model to generate the first common model.

9. The method according to claim 8, wherein the performing, by the first processing node, aggregation processing on the at least one first model to generate the first common model comprises:
processing, by the first processing node, parameters of the at least one first model to generate the first common model.

10. The method according to claim 9, wherein the processing, by the first processing node, parameters of the at least one first model to generate the first common model comprises:
performing, by the first processing node, average processing on the parameters of the at least one first model to generate the first common model, wherein a value of a parameter of the first common model is an average value of the parameters of the at least one first model.

11. The method according to claim 9, wherein
the at least one first model has a same network structure.

12. The method according to claim 11, wherein the method further comprises:
performing, by the first processing node, distillation processing on the at least one first model, wherein the distillation processing enables the at least one first model to have the same network structure.

13. The method according to claim 8, wherein the performing, by the first processing node, aggregation processing on the at least one first model to generate the first common model comprises:
splicing, by the first processing node, the at least one first model to generate the first common model.

14. The method according to claim 1, wherein
the at least one first model comprises a second common model, and the second common model is a common model obtained through a previous round of model processing.

15. The method according to claim 14, wherein the method further comprises:
receiving, by the first processing node, the second common model from a third processing node, wherein the third processing node is a processing node for the previous round of model processing.

16. The method according to claim 1, wherein the second processing node is determined based on one or more pieces of the following information:
a network topology structure, data quality of the second processing node, and a computing capability of the second processing node.

17. A model training apparatus, comprising at least one processor, and one or more memories coupled to the at least one processor and storing programming instructions for execution by the at least one processor to perform operations comprising
obtaining at least one first model;
processing the at least one first model to generate a first common model; and
determining a second processing node, wherein the second processing node is a processing node for a next round of model processing, and the first common model is obtained by the second processing node before the next round of model processing.

18. The apparatus according to claim 17, wherein the apparatus and the second processing node are different processing nodes, and the operations further comprise:
sending the first common model to the second processing node.

19. The apparatus according to claim 17, wherein
the apparatus and the second processing node are a same processing node.

20. The apparatus according to claim 17, wherein the operations further comprise:
determining the second processing node based on an indication of the first common model.
